(19) United States
(12) Patent Application Publication
(10) Pub. No.: US 2007/0057869 A1
(43) Pub. Date: Mar. 15, 2007

(54) Method of driving plasma display apparatus

(75) Inventor: Jeong Pil Choi, Suwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/517,266

(22) Filed: Sep. 8, 2006

(30) Foreign Application Priority Data
Sep. 9, 2005 (KR) 10-2005-0084325

(51) Int. Cl. G09G 3/28

(52) U.S. Cl. 345/60

(57) ABSTRACT

A method of driving a plasma display apparatus comprising an m-th scan electrode group and an n-th scan electrode group scanned later than the m-th scan electrode group is disclosed. The method comprises supplying a first setup pulse rising from a first voltage to a second voltage to the m-th scan electrode group during a setup period of a reset period, and supplying a second setup pulse rising from the first voltage to a third voltage that is higher than the second voltage to the n-th scan electrode group during the setup period of the reset period.

This Nonprovisional application claims priority under 35 U.S.C. § 119(a) on Patent Application No. 10-2005-0084325 filed in Korea on Sep. 9, 2005 the entire contents of which are hereby incorporated by reference.

### BACKGROUND

1. Field

The present invention relates to a driving method of a plasma display apparatus.

2. Description of the Related Art

The plasma display apparatus comprises a plasma display panel filled with a main discharge gas and inert gases in its discharge cell. If a high frequency voltage is supplied to electrodes of the plasma display panel, then the inert gases generate vacuum ultraviolet rays and the vacuum ultraviolet rays excite phosphors formed between barrier ribs of the plasma display panel to light emit.

The plasma display apparatus display images on each of sub-fields constituting a frame. Each sub-field comprises a reset-period for initializing discharge cells, an address period for selecting cells to be discharged, and a sustain period for implementing a gray level according to the number of time of discharge.

At a setup period of the reset period, a setup pulse is supplied to scan electrodes. A weak dark discharge is occurred in the discharge cells by the setup pulse. Positive wall charges are accumulated on address an electrode and a sustain electrode of the plasma display panel, and negative wall charges on a scan electrode by the dark discharge from the setup pulse

At a set-down period of the reset period, a set-down pulse is supplied to scan electrodes. Some of the wall charges accumulated excessively on the scan electrode are eliminated, and the wall charges in the discharge cells are distributed uniformly.

In the address period, a scan pulse is supplied to the scan electrodes, and a data pulse to the address electrode. A discharge cell is selected with a voltage difference between the scan pulse and the data pulse added to the wall voltage created during the reset period.

In the sustain period, a sustain pulse is supplied to the scan electrodes and sustain electrodes, and a sustain discharge is occurred at the discharge cell selected in the address period. Accordingly, the plasma display apparatus displays images.

### SUMMARY

In an aspect, a method of driving a plasma display apparatus comprising an m-th scan electrode group and an n-th scan electrode group scanned later than the m-th scan electrode group, comprises supplying a first setup pulse rising from a first voltage to a second voltage to the m-th scan electrode group during a setup period of a reset period and supplying a second setup pulse rising from the first voltage to a third voltage that is higher than the second voltage to the n-th scan electrode group during the setup period of the reset period.

In another aspect, a method of driving a plasma display apparatus comprising a p-th scan electrode and a q-th scan electrode scanned later than the p-th scan electrode, comprises supplying a first setup pulse rising from a first voltage to a second voltage to the p-th scan electrode during a setup period of a reset period and supplying a second setup pulse rising from the first voltage to a third voltage that is higher than the second voltage to the q-th scan electrode during the setup period of the reset period.

In still another aspect, a method of driving a plasma display apparatus comprising an m-th scan electrode group and an n-th scan electrode group scanned later than the m-th scan electrode group, the method comprises supplying a first set-down pulse falling from a first voltage to a second voltage to the m-th scan electrode group during a set-down period of a reset period and supplying a second set-down pulse falling from the first voltage to a third voltage that is higher than the second voltage to the n-th scan electrode group during the set-down period of the reset period.

In further still another aspect, a method of driving a plasma display apparatus comprising a p-th scan electrode and a q-th scan electrode scanned later than the p-th scan electrode, the method comprises supplying a first set-down pulse falling from a first voltage to a second voltage to the p-th scan electrode during a set-down period of a reset period and supplying a second set-down pulse falling from the first voltage to a third voltage that is higher than the second voltage to the q-th scan electrode during the set-down period of the reset period.

### BRIEF DESCRIPTION OF THE DRAWINGS

The embodiment of the invention will be described in detail with reference to the following drawings in which like numerals refer to like elements.

FIGS. 1a and 1b illustrate a plasma display apparatus according to a first embodiment of the present invention.

FIGS. 2a and 2b illustrate operations of a scan driver in the plasma display apparatus according to the first embodiment of the present invention.

FIGS. 3 t o 5 i llustrate sc an electrode groups driven by the scan driver in the plasma display apparatus according to the first embodiment of the present invention.

FIGS. 6a and 6b illustrate a driving signal of the plasma display apparatus according to the first embodiment of the present invention.

FIGS. 7a to 7d illustrate another driving signal of the plasma display apparatus according to the first embodiment of the present invention.

FIGS. 8a and 8b illustrate still another driving signal of the plasma display apparatus according to the first embodiment of the present invention.

FIG. 9 illustrates the amount of wall charges on the electrodes in case of the driving signal shown in FIG. 8a is supplied.

FIG. 10 illustrates further still another driving signal of the plasma display apparatus according to the first embodiment of the present invention.

FIG. 11 illustrates the adjustment of point of time for supplying between scan pulses.

FIGS. 12a and 12b illustrate further still another driving signal of the plasma display apparatus according to the first embodiment of the present invention.

FIG. 12c illustrates a scan driver for generating the driving signal of FIG. 12a.

FIG. 12d is a timing diagram for an operation of the scan driver of FIG. 12c.

FIG. 13 illustrates a plasma display apparatus according to a second embodiment of the present invention.

FIGS. 14a and 14b illustrate an operation of a scan driver in the plasma display apparatus according to the second embodiment of the present invention.

FIGS. 15a and 15b illustrate a driving signal of the plasma display apparatus according to the second embodiment of the present invention.

FIGS. 16a to 16d illustrate another driving signal of the plasma display apparatus according to the second embodiment of the present invention.

FIGS. 17a and 17b illustrate still another driving signal of the plasma display apparatus according to the second embodiment of the present invention.

FIG. 18 illustrates further still another driving signal of the plasma display apparatus according to the second embodiment of the present invention.

FIG. 19 illustrates the adjustment of point of time for supplying between scan pulses.

FIGS. 20a and 20b illustrate further still another driving signal of the plasma display apparatus according to the second embodiment of the present invention.

FIG. 20c is a timing diagram for an operation of the scan driver according to the second embodiment of the present invention.

FIG. 21 illustrates a driving signal of a plasma display apparatus according to a third embodiment of the present invention.

### DETAILED DESCRIPTION OF PREFERRED EMBODIMENTS

In an aspect, a method of driving a plasma display apparatus comprising an m-th scan electrode group and an n-th scan electrode group scanned later than the m-th scan electrode group, comprises supplying a first setup pulse rising from a first voltage to a second voltage to the m-th scan electrode group during a setup period of a reset period and supplying a second setup pulse rising from the first voltage to a third voltage that is higher than the second voltage to the n-th scan electrode group during the setup period of the reset period.

A duration of time when the first setup pulse is maintained at the second voltage may be higher than a duration of time when the second setup pulse is maintained at the third voltage.

A slope of the first setup pulse may be substantially equal to a slope of the second setup pulse.

The number of scan electrodes comprised in the m-th scan electrode group may be equal to the number of scan electrodes comprised in the n-th scan electrode group.

As the number of scan electrodes comprised in the m-th scan electrode group increases, a magnitude of the second voltage may increase.

A duration of a supply period of the first setup pulse may be less than a duration of a supply period of the second setup pulse.

A duration of a supply period of a set-down pulse supplied to the m-th scan electrode group may be substantially equal to a duration of a supply period of a set-down pulse supplied to the n-th scan electrode group.

In another aspect, a method of driving a plasma display apparatus comprising a p-th scan electrode and a q-th scan electrode scanned later than the p-th scan electrode, comprises supplying a first setup pulse rising from a first voltage to a second voltage to the p-th scan electrode during a setup period of a reset period and supplying a second setup pulse rising from the first voltage to a third voltage that is higher than the second voltage to the q-th scan electrode during the setup period of the reset period.

The p-th scan electrode and the q-th scan electrode may be adjacent to each other, and after completing the supplying of a scan pulse to the p-th scan electrode, a scan pulse may be supplied to the q-th scan electrode subsequent to a pause period.

A duration of the pause period may range from 50 ns to 100 μs.

In still another aspect, a method of driving a plasma display apparatus comprising an m-th scan electrode group and an n-th scan electrode group scanned later than the m-th scan electrode group, the method comprises supplying a first set-down pulse falling from a first voltage to a second voltage to the m-th scan electrode group during a set-down period of a reset period and supplying a second set-down pulse falling from the first voltage to a third voltage that is higher than the second voltage to the n-th scan electrode group during the set-down period of the reset period.

A duration of time when the first set-down pulse may be maintained at the second voltage is less than a duration of time when the second set-down is maintained at the third voltage.

A slope of the first set-down pulse may be substantially equal to a slope of the second set-down pulse.

The number of scan electrodes comprised in the m-th scan electrode group may be equal to the number of scan electrodes comprised in the n-th scan electrode group.

As the number of scan electrodes comprised in the n-th scan electrode group decreases, a magnitude of the third voltage may increase.

A duration of a supply period of the first set-down pulse may be more than a duration of a supply period of the second set-down pulse.

A duration of a supply period of a set-up pulse supplied to the m-th scan electrode group may be substantially e qual to a duration of a supply period of a set-down up supplied to the n-th scan electrode group.

In further still another aspect, a method of driving a plasma display apparatus comprising a p-th scan electrode and a q-th scan electrode scanned later than the p-th scan electrode, the method comprises supplying a first set-down pulse falling from a first voltage to a second voltage to the p-th scan electrode during a set-down period of a reset period and supplying a second set-down pulse falling from the first voltage to a third voltage that is higher than the second voltage to the q-th scan electrode during the set-down period of the reset period.

The p-th scan electrode and the q-th scan electrode may be adjacent to each other, and after completing the supplying of a scan pulse to the p-th scan electrode, a scan pulse may be supplied to the q-th scan electrode subsequent to a pause period.

A duration of the pause period may range from 50 ns to 100 μs.

Embodiments of the present invention will be described in a more detailed manner with reference to the drawings.

Hereinafter, exemplary implementations will be described in detail with reference to the attached drawings.

### <First Embodiment>

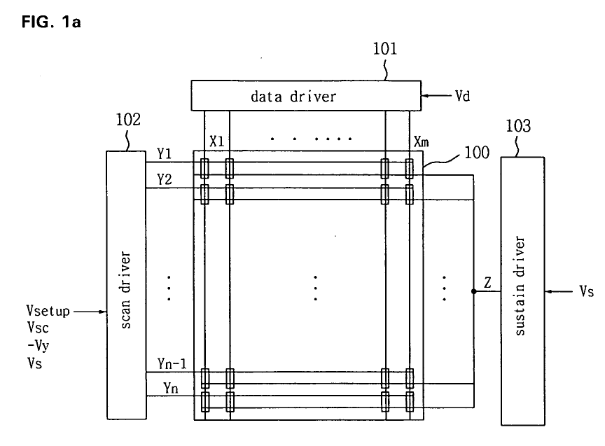

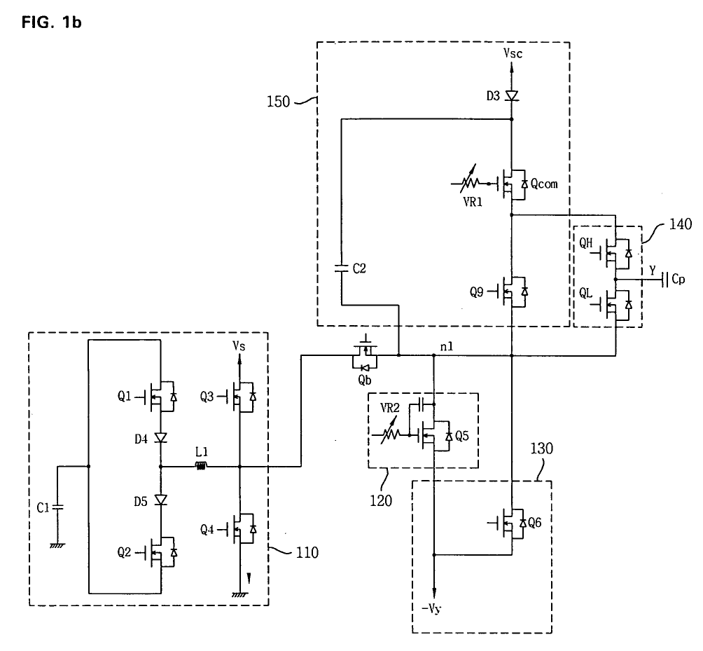

FIGS. 1a and 1b illustrate a plasma display apparatus according to a first embodiment of the present invention. As shown in FIG. 1a, a plasma display apparatus according to a first embodiment of the present invention comprises a plasma display panel 100, a data driver 101, a scan driver 102, and a sustain driver 103.

The plasma display panel 100 comprises scan electrodes Yl to Yn, a sustain electrode Z, and address electrodes X1 to Xm.

The data driver 101 supplies the address electrodes X1 to Xm with a data pulse corresponding to an image signal done with inverse gamma correction, error diffusion, and subfield mapping.

The scan driver 102 supplies a setup pulse and a set-down pulse to the scan electrodes Y1 to Yn during the setup period and set-down period of the reset period. The scan driver 102 also supplies the scan electrodes Y1 to Yn with a scan pulse during an address period and a sustain pulse during a sustain period.

The sustain driver 103 supplies a bias voltage to the sustain electrode Z during the set-down period and address period, and a sustain pulse to the sustain electrode Z during the sustain period.

FIG. 1b illustrates a scan driver in the plasma display apparatus according to the first embodiment of the present invention. As shown in FIG. lb, the scan driver in the plasma display apparatus according to the first embodiment of the present invention comprises an energy recovery circuit unit 110, a set-down supplying unit 120, a scan voltage supplying unit 130, a scan drive integrated circuit 140, and a setup/scan reference voltage supplying unit 150. A blocking switch Qb of FIG. 1b blocks electrical connection b etween the energy recovery circuit unit 110 and the set-down supplying unit 120 when the scan pulse is supplied to the scan electrode Y.

The energy recovery circuit unit 110 supplies a sustain voltage Vs to the scan electrode Y and recovers a reactive energy from the scan electrode Y. The energy recovery circuit unit 110 comprises a capacitor C1 for storing energy to charge energy recovered from the scan electrode Y, an inductor L1 for creating resonance upon supplying and recovering reactive energy, a first switch Q1 for forming a path to supply reactive energy, a second switch Q2 for forming a path to recover reactive energy, a third switch Q3 for forming a path to supply a sustain voltage Vs. and a fourth switch Q4 for forming a path to supply a voltage of ground level GND.

A blocking switch Qb of the set-down supplying unit 120 is turned off and a fifth switch Q5 is turned on at the set-down period of the reset period. The fifth switch Q5 forms a set-down pulse falling gradually up to a scan voltage—Vy. The channel width of the set-down pulse is up to a second variable resistor VR2.

A sixth switch Q6 of the scan voltage supplying unit 130 supplies a scan pulse falling from a scan reference voltage Vsc to the scan voltage—Vy during the address period through the scan drive integrated circuit 140 to the scan electrode Y.

The scan drive integrated circuit 140 supplies the scan electrode Y with driving pulses from the energy recovery circuit unit 110, set-down supplying unit 120, scan voltage supplying unit 130, and setup/scan reference voltage supplying unit 150. A output line between a scan top switch QH and a scan bottom switch QL of the scan drive integrated circuit 140 is connected to the scan electrode Y. One scan drive integrated circuit 140 corresponds to one scan electrode Y.

The setup/scan reference voltage supplying unit 150 supplies the scan electrode Y with a setup pulse rising gradually from the sustain voltage Vs, which the energy recovery circuit unit 110 supplies through the scan drive integrated circuit 140 at the setup period of the reset period, to the sum of the sustain voltage Vs and scan reference voltage Vsc, and supplies the scan reference voltage Vsc to the scan electrode Y in the address period. The setup/scan reference voltage supplying unit 150 comprises a voltage adjustment capacitor C2, a setup/scan common switch Qcom, and an energy path selection switch Q9. The setup/scan reference voltage supplying unit 150 may further comprise a reverse current prevention unit D3 for blocking reverse current flowing from the setup/scan common switch 152 to the scan reference voltage source.

The voltage adjustment capacitor C2 stores the scan reference voltage Vsc. Accordingly, a voltage ( i.e. Vs+Vsc) corresponding to the sum of the scan reference voltage Vsc stored at the voltage adjustment capacitor C2 and the sustain voltage Vs supplied by the energy recovery circuit unit 110 is supplied to the setup/scan common switch Qcom.

The setup/scan common switch Qcom is on at the setup period of the reset period, and supplies the scan electrode with a setup pulse rising gradually from the sustain voltage Vs, and supplies the scan reference voltage Vsc to the scan electrode Y in the address period. The first variable resistor VR1 is connected to the gate of the setup/scan common switch 152.

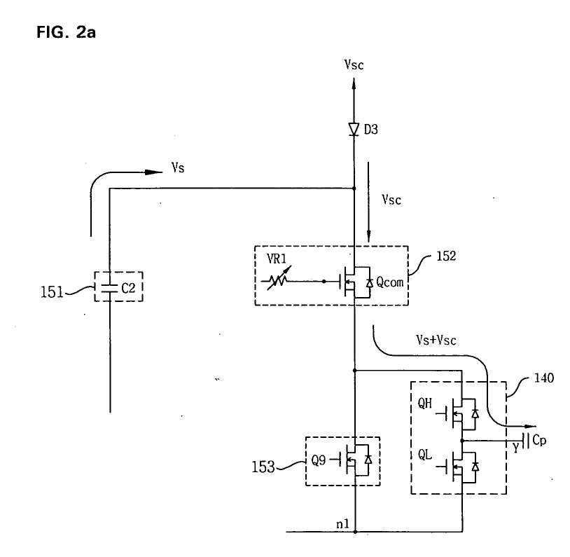

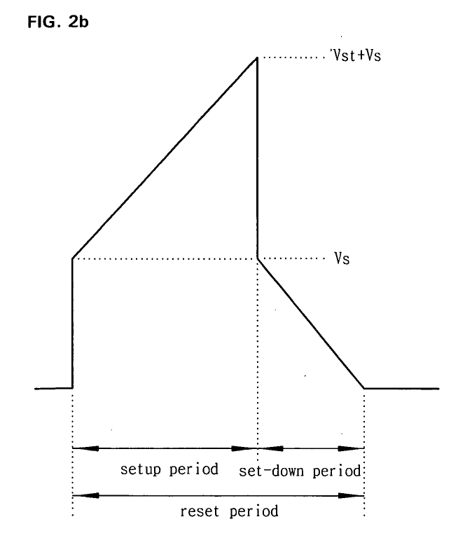

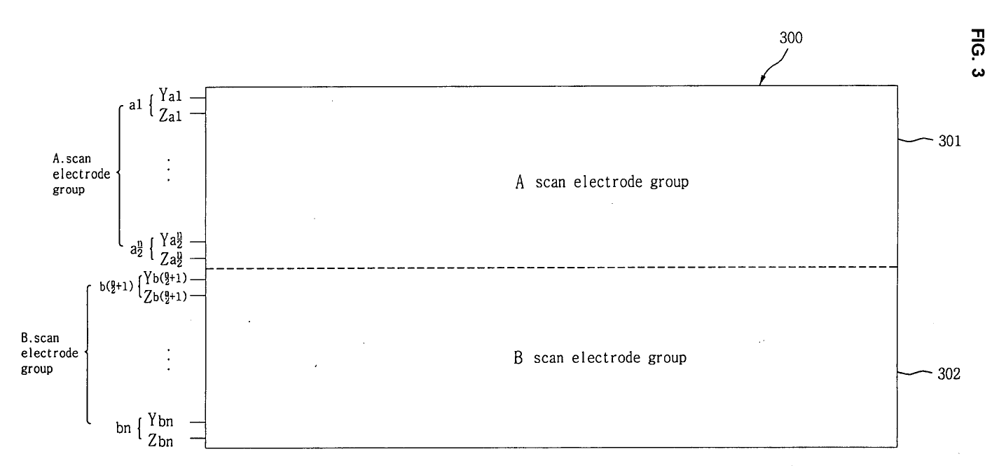

FIGS. 2a and 2b illustrate the operation of a scan driver in the plasma display apparatus according to the first embodiment of the present invention.

As shown in FIG. 2a, the energy recovery circuit unit 110 of FIG. 1b supplies the sustain voltage Vs at the setup period of the reset period, the voltage adjustment capacitor C2 stores the scan reference voltage Vs, and the setup/scan common switch Qcom is turned on. Accordingly, a voltage (i.e. Vs+Vsc) corresponding to the sum of the sustain voltage Vs and scan reference voltage Vsc is supplied to the setup/scan common switch 152.

The setup/scan common switch 152 supplies through the scan drive integrated circuit 140 to the scan electrode Y a setup pulse having a channel width adjusted by the first variable resistor VR1. The setup pulse rises gradually from the sustain voltage Vs to the sum voltage Vs+Vsc.

The setup/scan common switch 152 is turned off at the set-down period of the reset period. The set-down supplying unit 150 of FIG. lb supplies through the scan drive integrated circuit 140 a set-down pulse falling gradually from the sustain voltage Vs.

The highest voltage of the setup pulse is decided by turn-on maintaining period of the setup/scan common switch Q corn according to the operation of the setup/scan common switch Qcom of the scan driver. That is, the longer the turn-on maintaining period of the setup/scan common switch Qcom is, the higher the highest voltage of the setup pulse is.

The scan driver of the plasma display apparatus according to the first embodiment of the present invention may drive a scan electrode group comprising one and more scan electrodes.

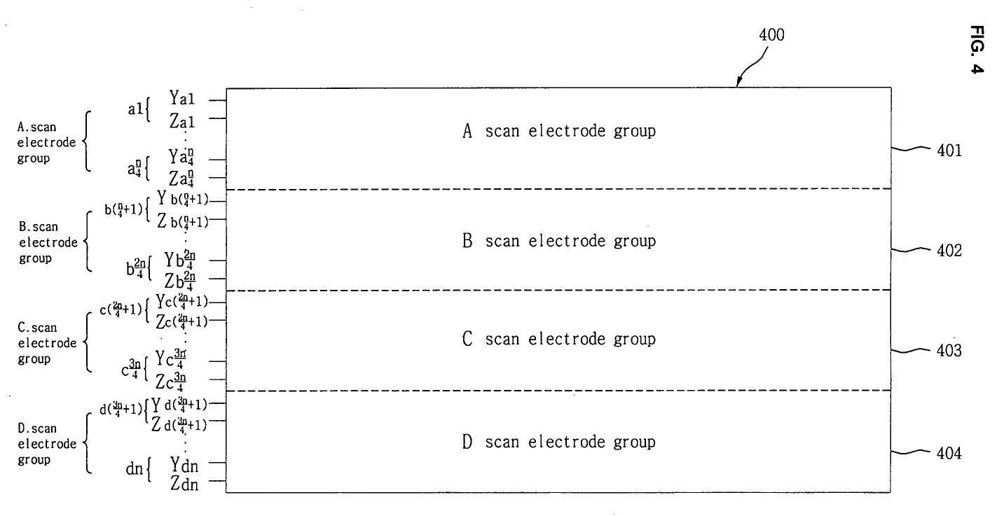

FIGS. 3 to 5 illustrate a scan electrode group driven by the scan driver in the plasma display apparatus according to the first embodiment of the present invention.

As shown in FIG. 3, the scan driver may drive A scan electrode group 301 and B scan electrode group 302 of the plasma display panel 300. The A scan electrode group 301 comprises Ya1 scan electrode to Ya(n/2) scan electrode. The B scan electrode group 302 comprises Yb((n/2)+1) scan electrode to Ybn scan electrode. The number of scan electrodes comprised in the A scan electrode group 301 is equal to that of the B scan electrode group 302. If the total number of the scan electrode groups is 2, then manufacturing cost of the scan driver can be reduced.

The scan driver supplies the scan electrodes comprised in any one scan electrode group with a scan pulse sequentially. That is, the scan driver supplies the Ya1 scan electrode thorough Ya(n/2) scan electrode with a scan pulse sequentially, and supplies the Yb((n/2)+1) thorough Ybn with a scan pulse sequentially.

As shown in FIG. 4, the scan driver may drive A scan electrode group 401 to D scan electrode group 404 of the plasma display panel 400. The A scan electrode group 401 comprises Ya1 scan electrode to Ya(n/4) scan electrode. The B scan electrode group 402 comprises Yb((n/4)+1) scan electrode to Yb((2n)/4) scan electrode. The C scan electrode group 403 comprises Yc((2n/4)+1) scan electrode to Yc(3n)/4 scan electrode. The D scan electrode group 404 comprises Yd((3n/4)+1) scan electrode to Ydn scan electrode. The number of scan e lectrodes comprised in each of the A scan electrode group 401 to D scan electrode group 404 is equal to each other. The scan driver supplies the scan electrodes comprised in any one scan electrode group with a scan pulse sequentially.

In addition, as shown in FIG. 5, the number of scan electrodes comprised in each scan electrode group may be different from each other. For example, the A scan electrode group 501 may comprise 10 scan electrodes, B scan electrode group 502 5 scan electrodes, C scan electrode group 503 1 scan electrode, D scan electrode group 504 44 scan electrodes, and E scan electrode group 505 40 scan electrodes. In addition, the number of scan electrodes comprised in at least one scan electrode group among a plurality of scan electrode groups may be different from that comprised in the other scan electrode group. In addition, the scan driver supplies the scan electrodes comprised in each scan electrode group with a scan pulse sequentially.

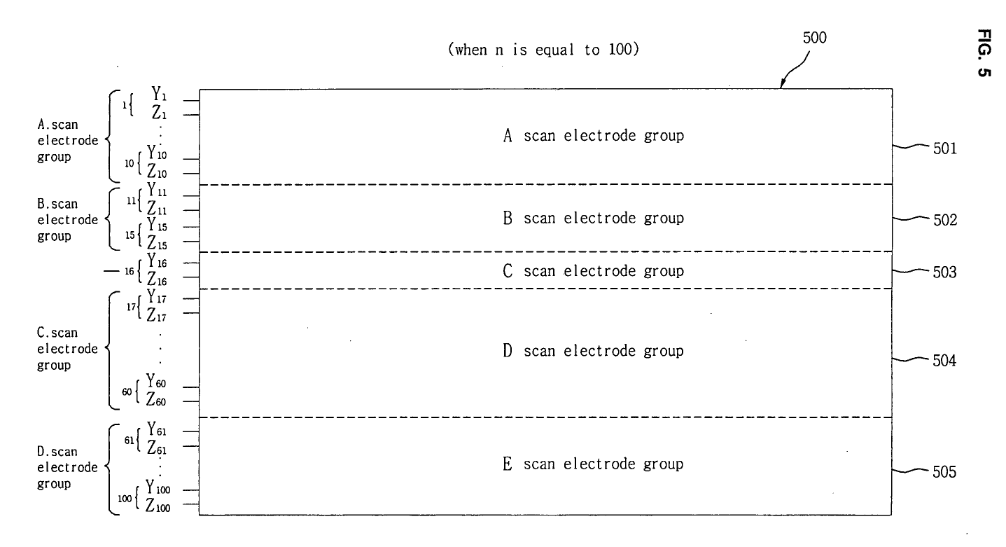

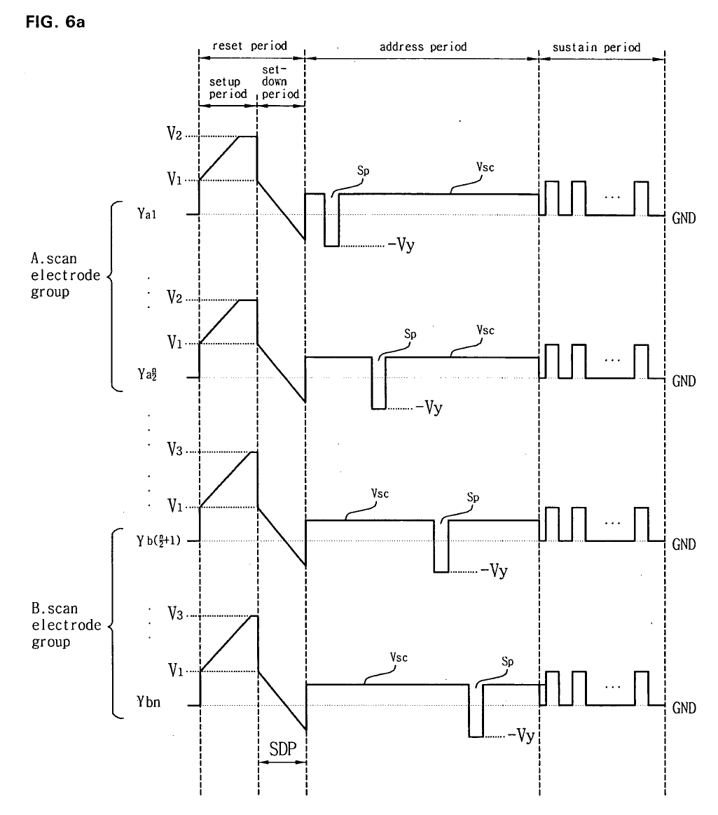

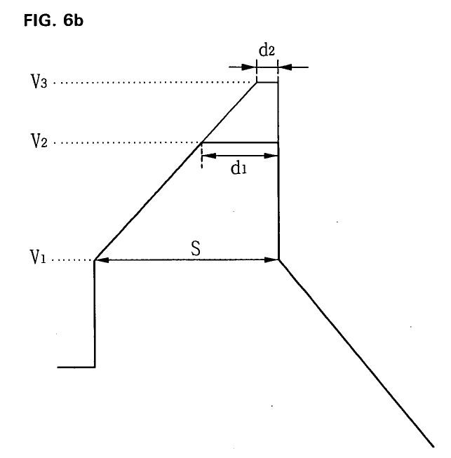

FIGS. 6a and 6b illustrate driving signals of the plasma display apparatus according to the first embodiment of the present invention. The scan driver supplies a scan pulse to the B scan electrode group later than the A scan electrode group. The scan driver supplies the A scan electrode group with a first setup pulse rising from a first voltage V1 to a second voltage V2 and the B scan electrode group with a second setup pulse rising from the first voltage V1 to a third voltage V3 higher than the second voltage V2 at the setup period of the reset period. Accordingly, as also shown in FIG. 6b, a duration dl when the second voltage V2 of the first setup pulse is maintained may be longer than a duration d2 when the third voltage V3 of the second setup pulse is maintained. Moreover, a slope of the first setup pulse may be substantially equal to that of the second setup pulse such that the scan driver may be readily to be timing- controlled.

The scan driver supplies a set-down pulse to each scan electrode group at the set-down period of the reset period, and the supply period SDP of the set-down pulse may be substantially equal.

FIG. 6b illustrates the first setup pulse and second setup pulse of FIG. 6a in more detail. As shown in FIG. 6b, the magnitude V2 of the highest voltage of the first setup pulse supplied to the A scan electrode group having faster scan order is smaller than the magnitude V3 of the highest voltage of the second setup pulse supplied to the B scan electrode group having slower scan order. Accordingly, the strength of a reset discharge of the A scan electrode group is smaller than that of the B scan electrode group, and the amount of wall charges of the A scan electrode group is also smaller than that of the B scan electrode group.

Thus, since the amount of charges on the B scan electrode group is greater than that on the A scan electrode group, although the amount of charges to be eliminated by combination of wall charges on the B scan electrode group and space charges is larger than the amount of charges to be eliminated by combination of wall charges on the A scan electrode group and space charges, the difference between the amount of wall charges on the A scan electrode group and the amount of wall charges on the B scan electrode group is reduced.

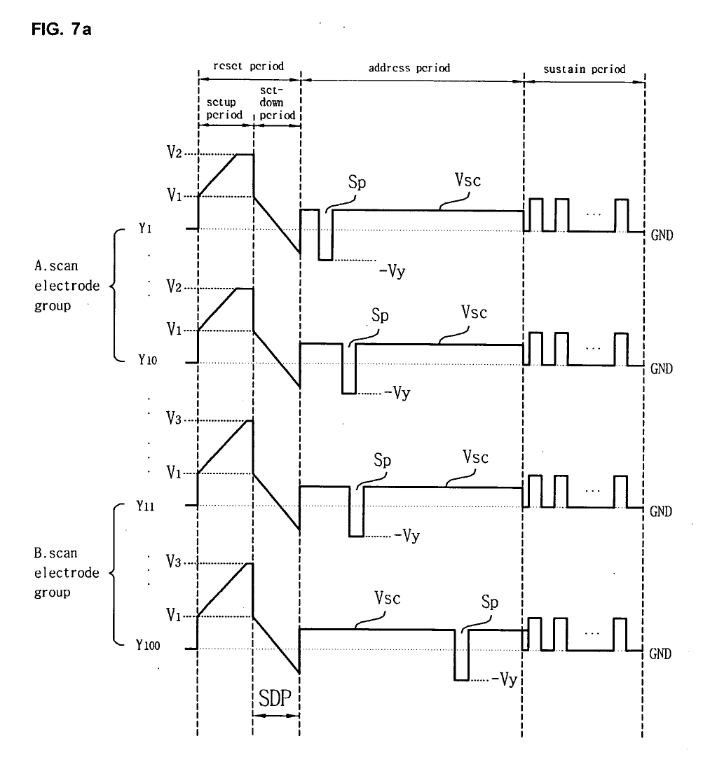

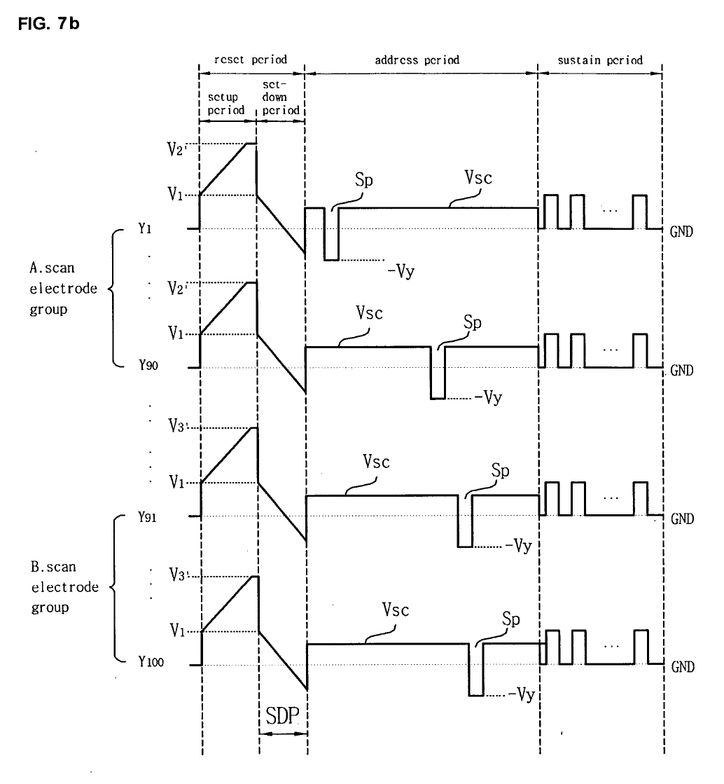

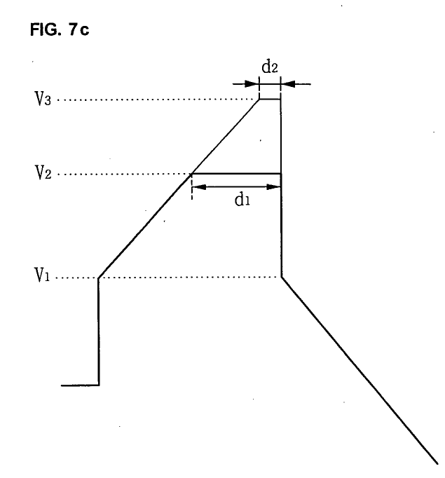

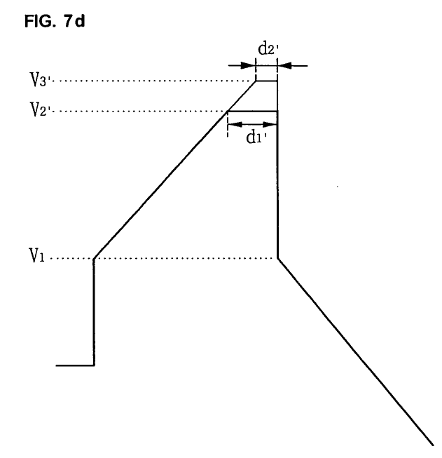

FIGS. 7a to 7d illustrate another driving signals of the plasma display apparatus according to the first embodiment of the present invention.

The A scan electrode group and B scan electrode group of FIG. 7a comprise 10 and 90 scan electrodes, respectively, and the A scan electrode group and B scan electrode group of FIG. 7b comprise 90 and 10 scan electrodes, respectively.

As shown in FIG. 7a, the scan driver supplies the A scan electrode group with a first setup pulse rising gradually from a first voltage V1 to a second voltage V2, and supplies the B scan electrode group to be scanned later than the A scan electrode group with a second setup pulse rising gradually from the first voltage V1 to a third voltage V3. The third voltage V3 is higher than the second voltage V2.

As shown in FIG. 7b, the scan driver supplies the A scan electrode group with a first setup pulse rising gradually from the first voltage V1 to a second voltage V2′, and supplies the B scan electrode group to be scanned later than the A scan electrode group with a second setup pulse rising gradually from the first voltage V1 to a third voltage V3′. The third voltage V3′ is higher than the second voltage V2′.

The scan driver supplies a set-down pulse to each scan electrode group at the set-down period of the reset period, and the supply period SDP of the set-down pulse may be substantially equal.

As shown in FIG. 7c, the second voltage V2′ of FIG. 7b is higher than the second voltage V2 of FIG. 7a, and a duration d1′, when the second voltage V2′ of FIG. 7b is maintained, is shorter than a duration dl, when the second voltage V2 of FIG. 7a is maintained. In addition, the third voltage V3′ of FIG. 7b is substantially equal to the third voltage V3 of FIG. 7a. That is, as the number of scan electrodes comprised in the A scan electrode group increases, so the magnitude of the second voltage may increase.

The reason why the second voltage V2′ of FIG. 7b is higher than the second voltage V2 of FIG. 7a is to compensate sufficiently the difference between the amount of wall charges on the B scan electrode group to be scanned late and the amount of wall charges on the A scan electrode group to be scanned fast.

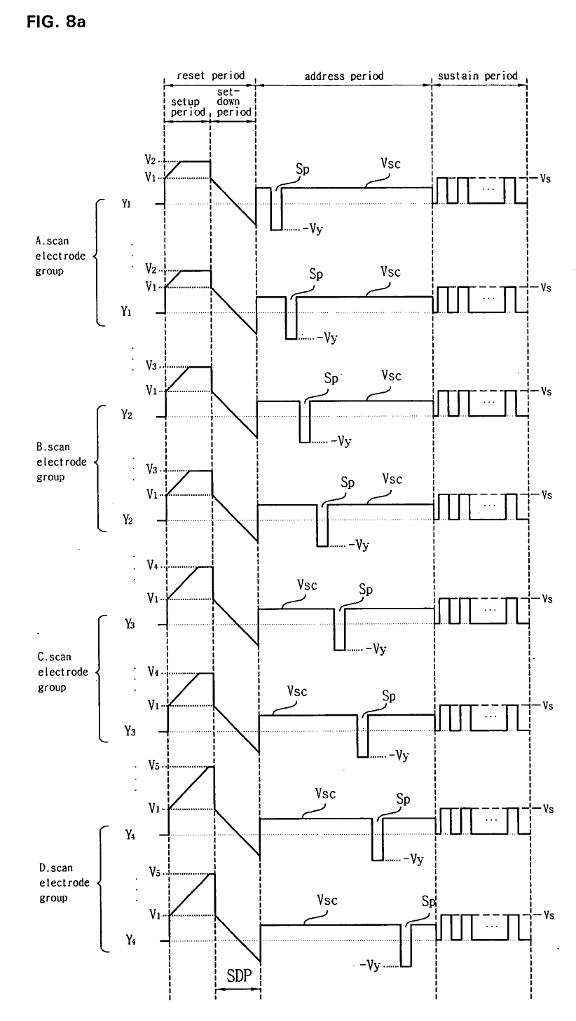

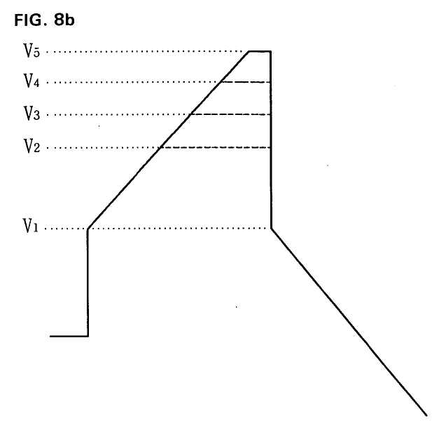

FIGS. 8a and 8b illustrate still another driving signal of the plasma display apparatus according to the first embodiment of the present invention.

As shown in FIG. 8a, the scan driver supplies a setup pulse with A scan electrode group, B scan electrode group, C scan electrode group, and D scan electrode group sequentially, and may supply each of the A scan electrode group, B scan electrode group, C scan electrode group, and D scan electrode group with a setup pulse having the different highest voltages V2, V3, V4, and V5. As shown in FIG. 8, as the scanning order becomes late, so the highest voltage of the setup pulse increases, and this allows for compensating the amount of charges to be eliminated by combination of the wall charges on the scan electrode having later scanning order and space charges. Accordingly, a stable address discharge occurs during the address period, and the brightness difference according to the location of discharge cell decreases. In addition, as scanned rapidly, the highest voltage of the setup pulse and dark discharge is reduced, and this allows for improving the contrast property.

The scan driver supplies a set-down pulse to each scan electrode group at the set-down period of the reset period, and the supply period SDP of the set-down pulse may be substantially equal.

FIG. 9 illustrates the amount of wall charges on electrodes in case that the driving signal shown in FIG. 8a is supplied; the difference of the amount of wall charges on the A scan electrode group Y_{A}, B scan electrode group Y_{B}, C scan electrode group Y_{C}, and D scan electrode group Y_{D} is reduced.

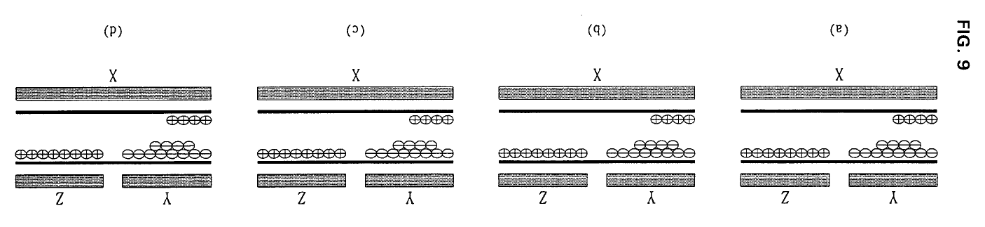

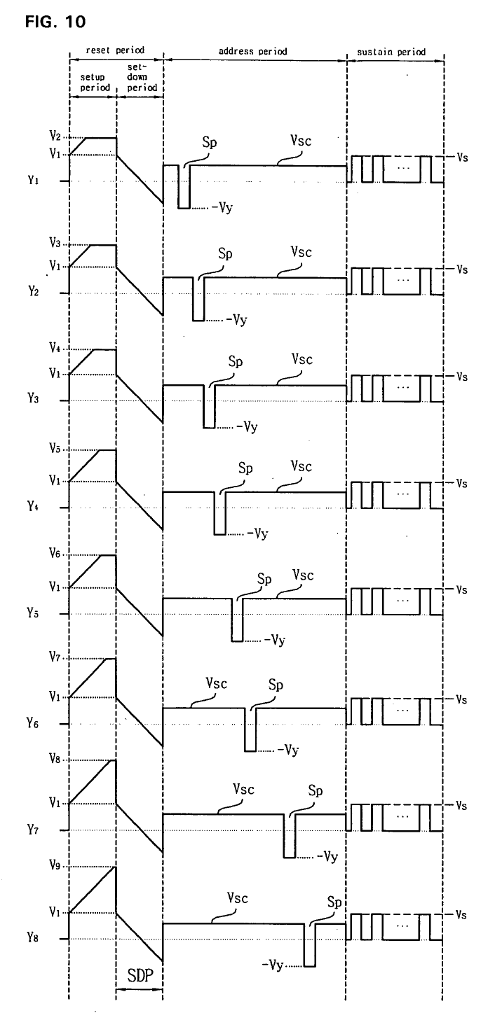

FIG. 10 illustrates further still another driving signal of the plasma display apparatus according to the first embodiment of the present invention. As shown in FIG. 10, a scan driver of a plasma display apparatus according to the first embodiment of the present invention, may supply a setup pulse having the lowest highest voltage V2 to a scan electrode Y1 to be scanned earliest, and supply a setup pulse having the maximum highest voltage V9 to a scan electrode Yn to be scanned latest. That is, the scan driver may supply a setup pulse having the different highest voltage to each of the scan electrodes.

The scan driver supplies a set-down pulse to each scan electrode group at the set-down period of the reset period, and the supply period SDP of the set-down pulse may be substantially equal.

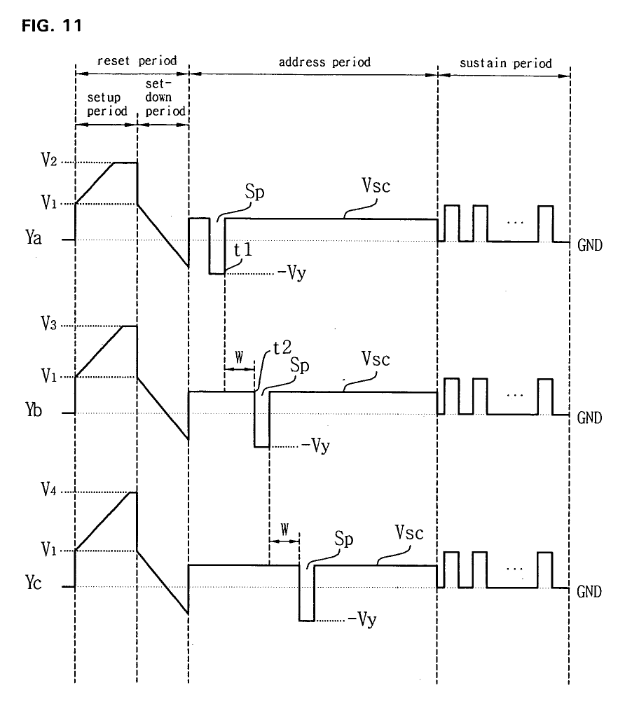

FIG. 11 illustrates the adjustment of point of time for supplying between scan pulses. As shown in FIG. 11, the scan driver adjusts the point of time supplying a scan pulse to prevent an error-discharge between two adjacent scan electrodes. For example, the scan driver stops supplying the scan pulse to the scan electrode Ya on supply ending point t1, and supplies the scan pulse to the scan electrode Yb on supply starting point t2 after pause period W. The pause period W may range from 50 ns to 100 μs

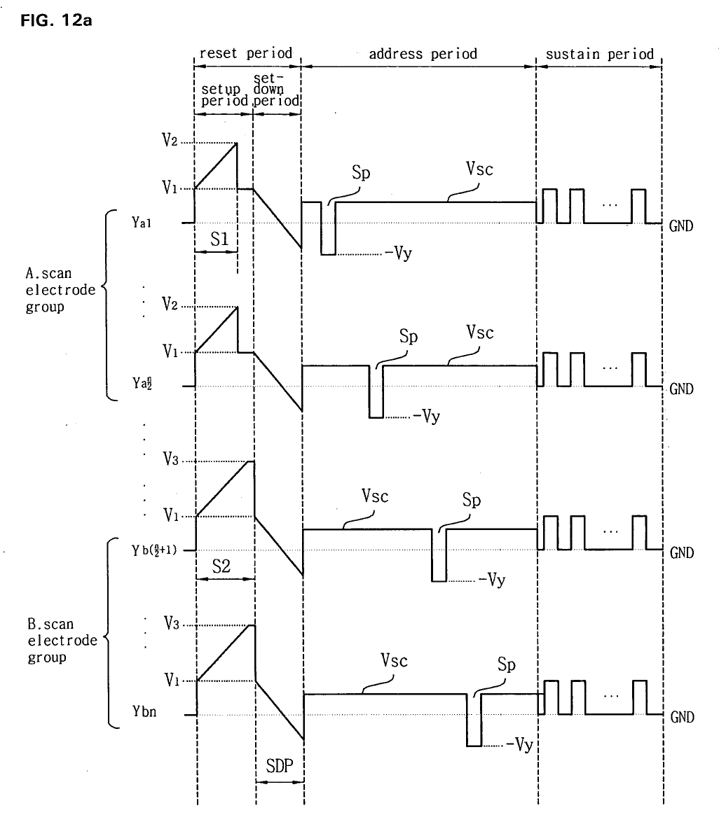

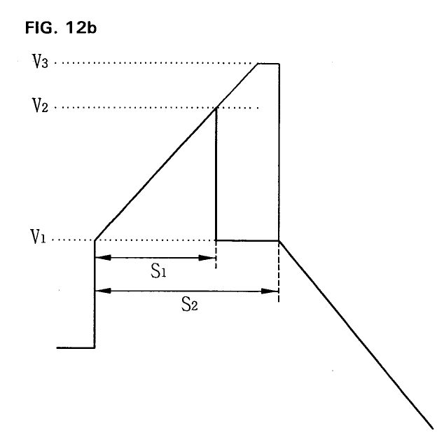

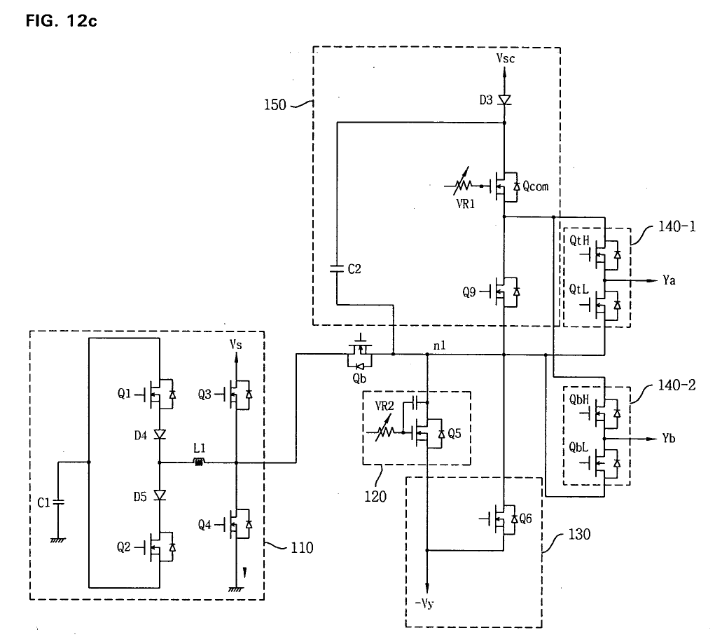

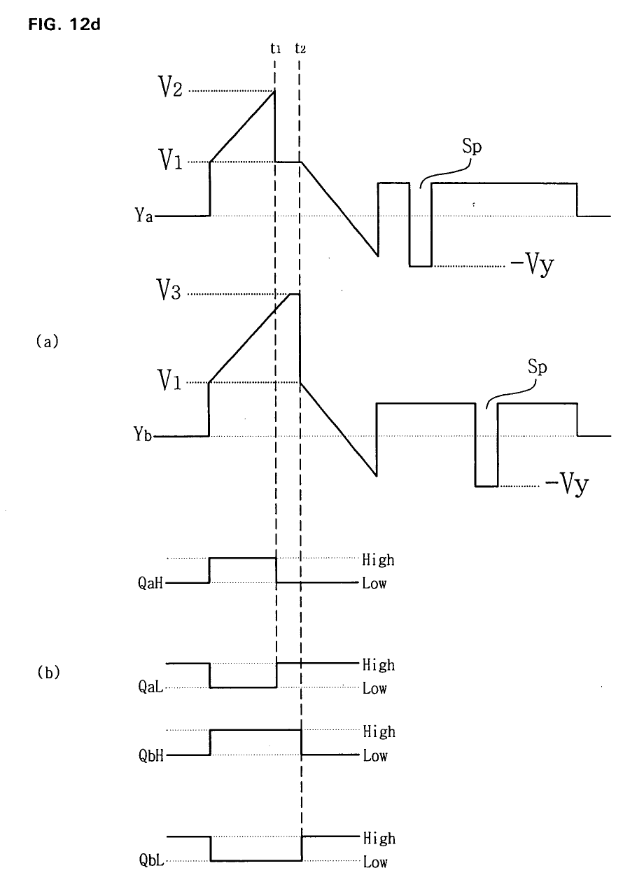

FIGS. 12a to 12d illustrate another driving signal of the plasma display apparatus according to the first embodiment of the present invention.

As shown in FIG. 12a, a scan driver of a plasma display apparatus according to the first embodiment of the present invention may make the highest voltage of a setup pulse high by the difference between periods S1, S2 when the setup pulse is supplied, as the scanning order becomes late. For example, as shown in FIGS. 12a and 12b, the scan driver supplies setup pulses having the same slope to A scan electrode group and B scan electrode group. In particular, the scan driver makes a period S1 of supplying a setup pulse to the A scan electrode group shorter than a period S2 of supplying a setup pulse to the B scan electrode group.

The scan driver supplies a set-down pulse to each scan electrode group at the set-down period of the reset period, and the supply period SDP of the set-down pulse may be substantially equal.

FIG. 12c illustrates a scan driver for generating the driving signal of FIG. 12a, and FIG. 12d is a timing diagram for an operation of the scan driver of FIG. 12c.

A scan driver of FIG. 12c comprises a scan drive integrated circuit 140-1 of supplying a setup pulse to A scan electrode group and a scan drive integrated circuit 140-2 of supplying a setup pulse to B scan electrode group to cause a difference between periods supplying a setup pulse.

As shown in FIG. 12d, the energy recovery circuit unit 110 supplies a sustain voltage Vs in the reset period, the voltage adjustment capacitor C2 stores a scan reference voltage Vs, and the setup/scan common switch Qcom is turned on. Scan top switches QaH, QbH of the scan drive integrated circuits 140-1, 140-2 are turned on, and their scan bottom switches QaL, QbL are turned off. Accordingly, the voltage of the A scan electrode group Ya and B scan electrode group Yb rises up to a first voltage V1.

The energy recovery circuit unit 110 supplies a sustain voltage (Vs=V1). The voltage adjustment capacitor C2 stores the scan reference voltage Vsc and the setup/scan common switch Qcom is turned on. The scan top switches QaH, QbH of the scan drive integrated circuits 140-1, 140-2 are kept to be turned on, and their scan bottom switches QaL, QbL are kept to be turned off. Accordingly, the voltage of the A scan electrode group Ya and B scan electrode group Yb rises gradually from the first voltage V1.

The scan top switch QaH of the scan drive integrated circuit 140-1 is turned off at point of time t1, and the scan bottom switch QaL is turned on at point of time t1. In addition, the scan top switch QbH and scan bottom switch QbL of the scan drive integrated circuit 140-2 maintain the switching state at point of time t1. Accordingly, the voltage of the A scan electrode group Ya falls from the second voltage V2, and the voltage of the B scan electrode group Yb rises up to the third voltage V3.

### <Second Embodiment>

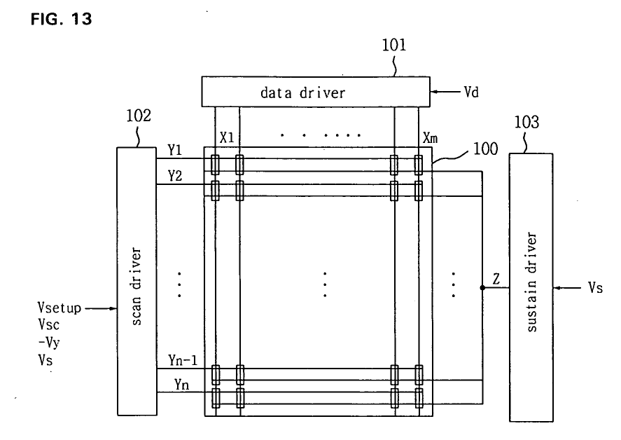

FIG. 13 illustrates a plasma display apparatus according to a second embodiment of the present invention. As shown in FIG. 13, a plasma display apparatus according to a first embodiment of the present invention comprises a plasma display panel 100, a data driver 101, a scan driver 102, and a sustain driver 103. The plasma display panel 100, data driver 101, and sustain driver 103 are similar to those in the first embodiment, and the detailed descriptions will be omitted.

The scan driver 102 supplies a setup pulse and a set-down pulse to the scan electrodes Y1 to Yn during the setup period and set-down period of the reset period. The scan driver 102 also supplies the scan electrodes Y1 to Yn with a scan pulse during an address period and a sustain pulse during a sustain period.

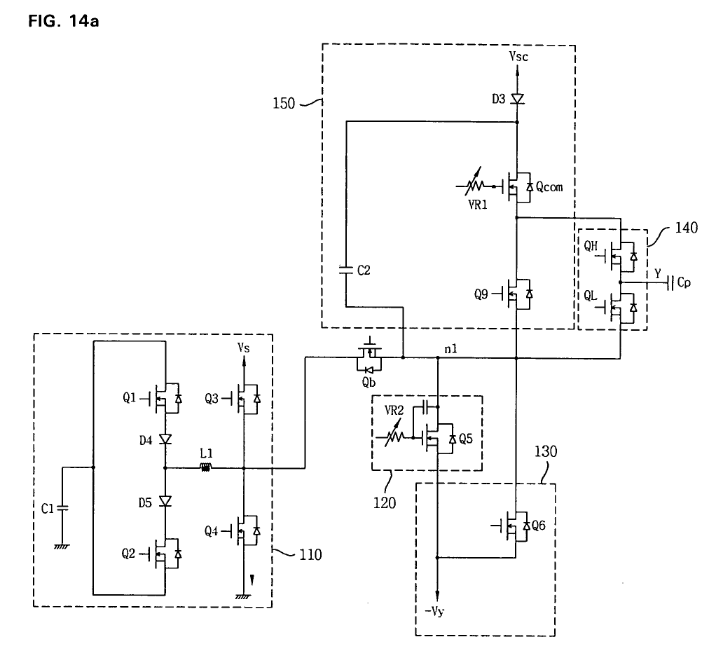

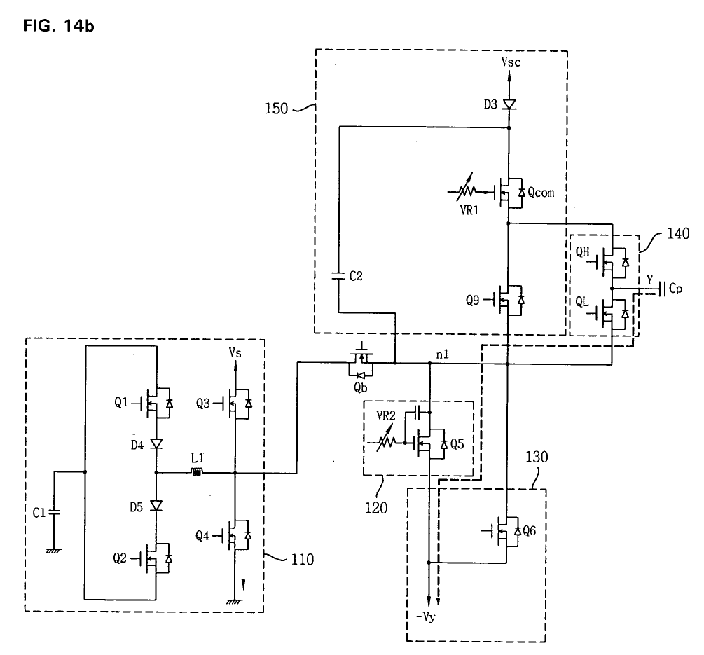

The operation of the scan driver in the plasma display apparatus according to the second embodiment of the present invention will be described in more detail with reference with FIGS. 14a and 14b.

FIGS. 14a and 14b illustrate an operation of a scan driver in the plasma display apparatus according to the second embodiment of the present invention. The operation of the scan driver at the setup period is similar to that in the first embodiment, and the detailed description will be omitted.

A fifth switch Q5 of the set-down supplying unit 150 and a bottom switch QL of the scan drive integrated circuit 140 are turned on at the set-down period of the reset period. Accordingly, a set-down pulse is supplied to the scan electrode Y, which has the channel width to be adjusted by a second variable resistor VR2. The lowest voltage of the set-down pulse is decided according to the turn-on duration of the fifth switch Q5. That is, the longer the turn-on duration of the fifth switch Q5 is, the lower the lowest voltage of the set-down pulse is.

The kinds of scan electrodes driven by the scan driver in the plasma display apparatus according to the second embodiment of the present invention is equal to those in the first embodiment illustrated in FIGS. 3 to 5, and the detailed description will be omitted.

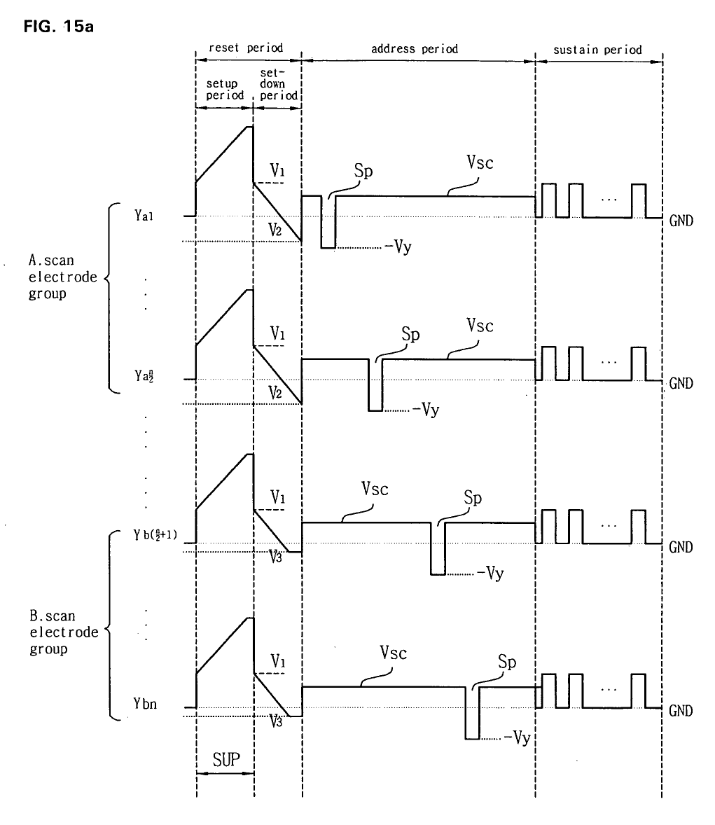

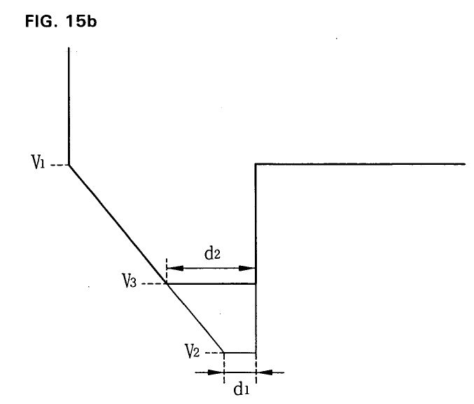

FIGS. 15a and 15b illustrate a driving signal of the plasma display apparatus according to the second embodiment of the present invention.

The scan driver supplies a scan pulse to the B scan electrode group later than the A scan electrode group. The scan driver supplies the A scan electrode group with a first setup pulse falling from a first voltage V1 to a second voltage V2, and the B scan electrode group with a setup pulse rising from the first voltage V1 to a third voltage V3 higher than the second voltage V2 at the set-down period of the reset period. Accordingly, as shown in FIG. 15b, a duration dl when the second voltage V2 of the first setup pulse is maintained may be longer than a duration d2 when the third voltage V3 of the second setup pulse is maintained. Moreover, a slope of the first setup pulse may be substantially equal to that of the second setup pulse such that the scan driver may be readily to be timing-controlled.

The scan driver supplies a setup pulse to each scan electrode group at the setup period of the reset period, and the supply period SUP of the setup pulse may be substantially equal.

FIG. 15b illustrates the first setup pulse and second setup pulse of FIG. 15a in more detail. As shown in FIG. 15b, the highest voltage V2 of the first setup pulse supplied to the A scan electrode group having faster scan order is lower than the highest voltage V3 of the second setup pulse supplied to the B scan electrode group having slower scan order. Accordingly, the strength of a reset discharge of the A scan electrode group is smaller than that of the B scan electrode group, and the amount of wall charges of the A scan electrode group is also smaller than that of the B scan electrode group.

Thus, since the amount of charges on the B scan electrode group is greater than that on the A scan electrode group, although the amount of charges to be eliminated by combination of wall charges on the B scan electrode group and space charges is larger than the amount of charges to be eliminated by combination of wall charges on the A scan electrode group and space charges, the difference between the amount of wall charges on the A scan electrode group and the amount of wall charges on the B scan electrode group is reduced.

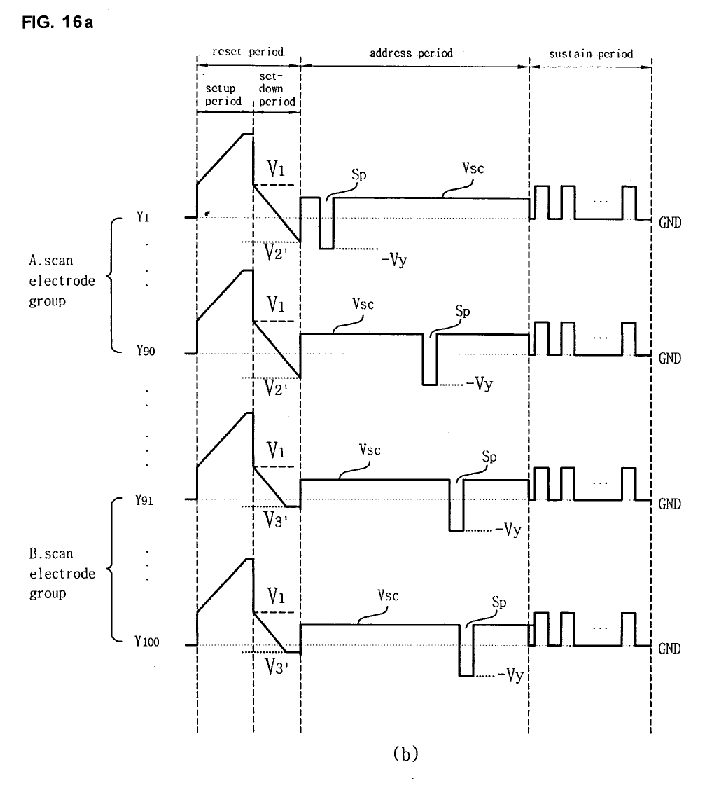

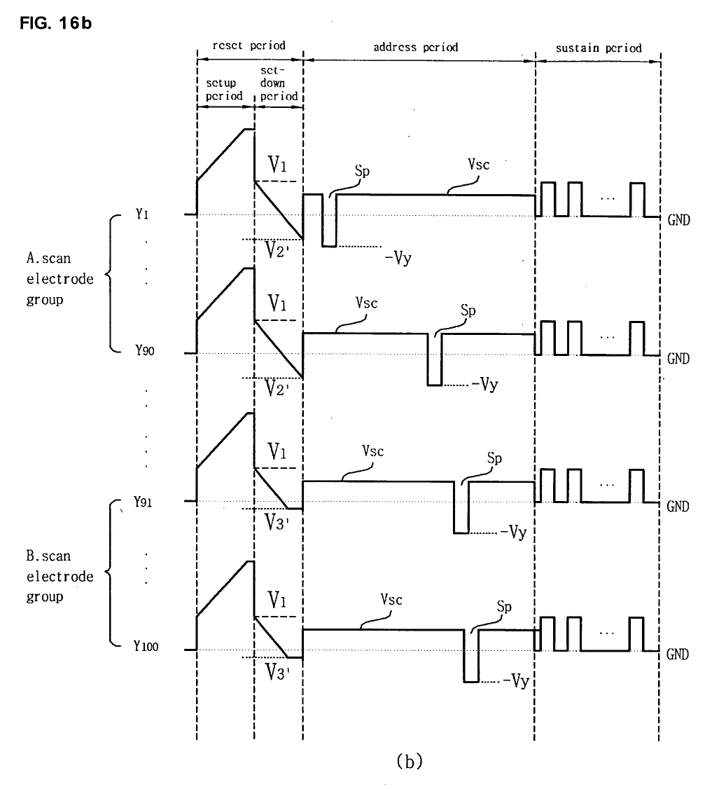

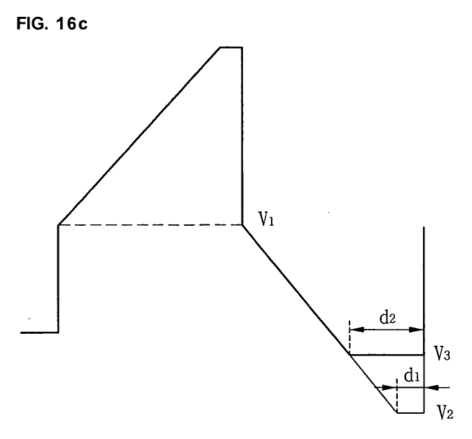

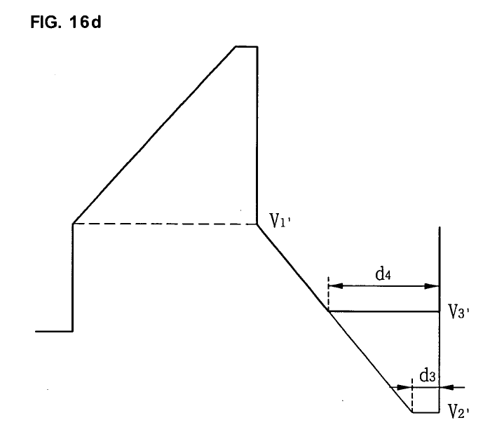

FIGS. 16a to 16d illustrate another driving signal of the plasma display apparatus according to the second embodiment of the present invention.

The A scan electrode group and B scan electrode group of FIG. 16a comprise 10 and 90 scan electrodes, respectively, and the A scan electrode group and B scan electrode group of FIG. 16b comprise 90 and 10 scan electrodes, respectively.

As shown in FIG. 16a, the scan driver supplies the A scan electrode group with a first set-down pulse rising gradually from a first voltage V1 to a second voltage V2, and supplies the B scan electrode group to be scanned later than the A scan electrode group with a second set-down pulse falling gradually from the first voltage V1 to a third voltage V3. The third voltage V3 is higher than the second voltage V2.

As shown in FIG. 16b, the scan driver supplies the A scan electrode group with a second set-down pulse falling gradually from the first voltage V1 to a second voltage V2′, and supplies the B scan electrode group to be scanned later than the A scan electrode group with a second setup pulse rising gradually from the first voltage V1 to a third voltage V3′. The third voltage V3′ is higher than the second voltage V2′.

The scan driver supplies a set-down pulse to each scan electrode group at the set-down period of the reset period, and the supply period SDP of the set-down pulse may be substantially equal.

As shown in FIG. 16c, the second voltage V2′ of FIG. 16b is higher than the second voltage V2 of FIG. 16a, and a duration d1′, when the second voltage V2′ of FIG. 16b is maintained, is shorter than a duration d1, when the second voltage V2 of FIG. 16a is maintained. In addition, the third voltage V3′ of FIG. 16b is substantially equal to the third voltage V3 of FIG. 16a. That is, as the number of scan electrodes comprised in the A scan electrode group increases, so the magnitude of the second voltage may increase.

The reason why the second voltage V2′ of FIG. 16b is higher than the second voltage V2 of FIG. 16a is to compensate sufficiently the difference between the amount of wall charges on the B scan electrode group to be scanned late and the amount of wall charges on the A scan electrode group to be scanned fast.

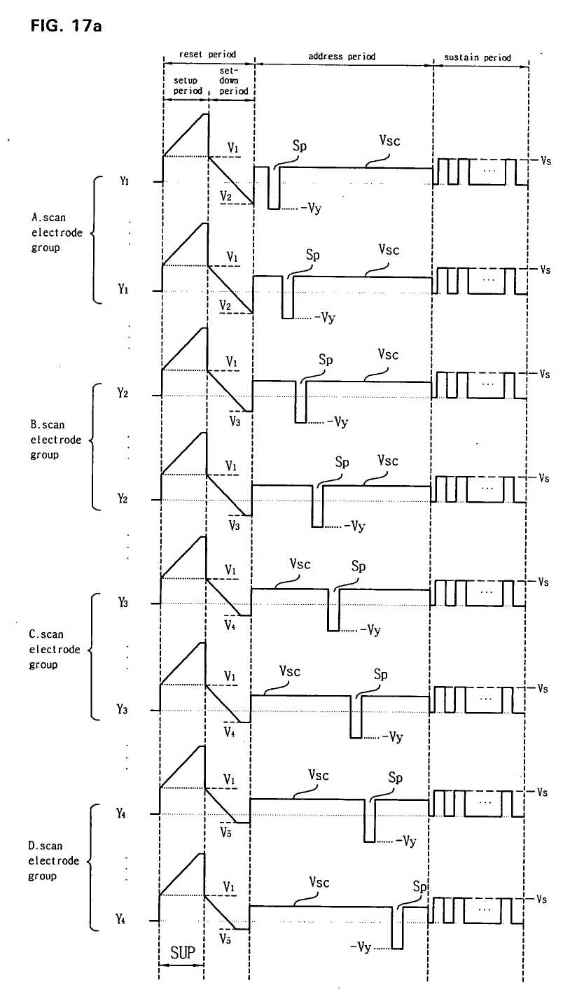

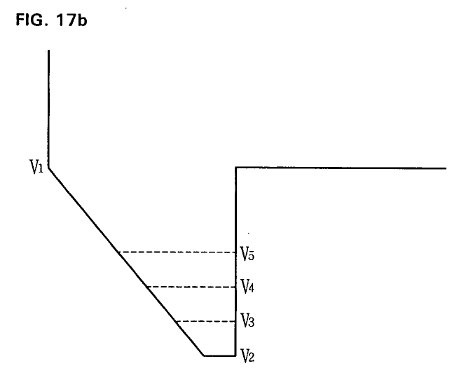

FIGS. 17a and 17b illustrate still another driving signal of the plasma display apparatus according to the second embodiment of the present invention.

As shown in FIG. 17a, the scan driver supplies a setup pulse with A scan electrode group, B scan electrode group, C scan electrode group, and D scan electrode group sequentially, and may supply each of the A scan electrode group, B scan electrode group, C scan electrode group, and D scan electrode group with a setup pulse having the different highest voltages V2, V3, V4, and V5. As shown in FIG. 17b, as the scanning order becomes late, so the lowest voltage of the set-down pulse increases, and this allows for compensating the amount of charges to be eliminated by combination of the wall charges on the scan electrode having later scanning order and space charges. Accordingly, a stable address discharge occurs during the address period, and the brightness difference according to the location of discharge cell decreases. In addition, as scanned rapidly, the highest voltage of the setup pulse and dark discharge is reduced, and this allows for improving the contrast property.

The scan driver supplies a set-down pulse to each scan electrode group at the set-down period of the reset period, and the supply period SDP of the set-down pulse may be substantially equal.

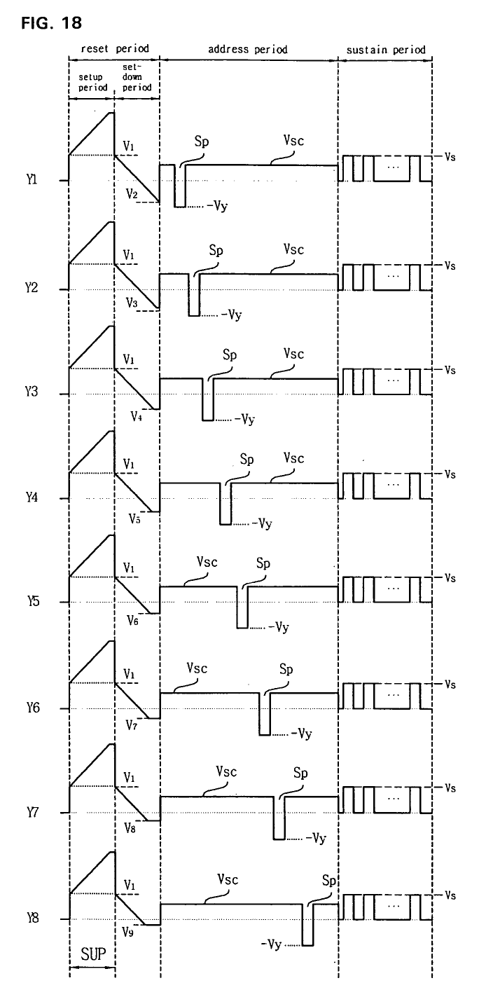

FIG. 18 illustrates further still another driving signal of the plasma display apparatus according to the second embodiment of the present invention. As shown in FIG. 18, a scan driver of a plasma display apparatus according to the second embodiment of the present invention, may supply a setup pulse having the minimum lowest voltage V2 to a scan electrode Y1 to be scanned earliest, and supply a setup pulse having the highest lowest voltage V9 to a scan electrode Yn to be scanned latest.

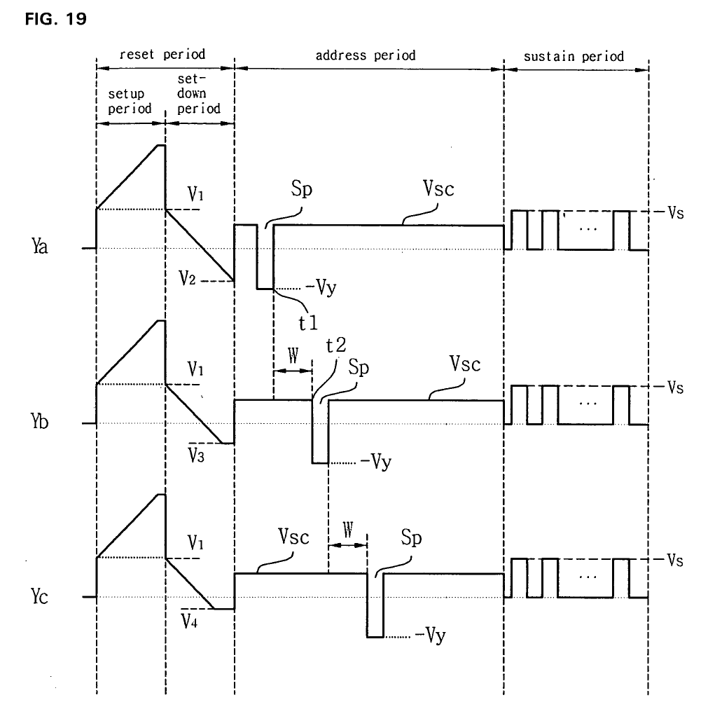

FIG. 19 illustrates the adjustment of point of time for supplying between scan pulses. As shown in FIG. 19, the scan driver adjusts the point of time supplying a scan pulse to prevent an error-discharge between two adjacent scan electrodes. For example, the scan driver stops supplying the scan pulse to the scan electrode Ya on supply ending point t1, and supplies the scan pulse to the scan electrode Yb on supply starting point t2 after pause period W. The pause period W may range from 50 ns to 100 μs .

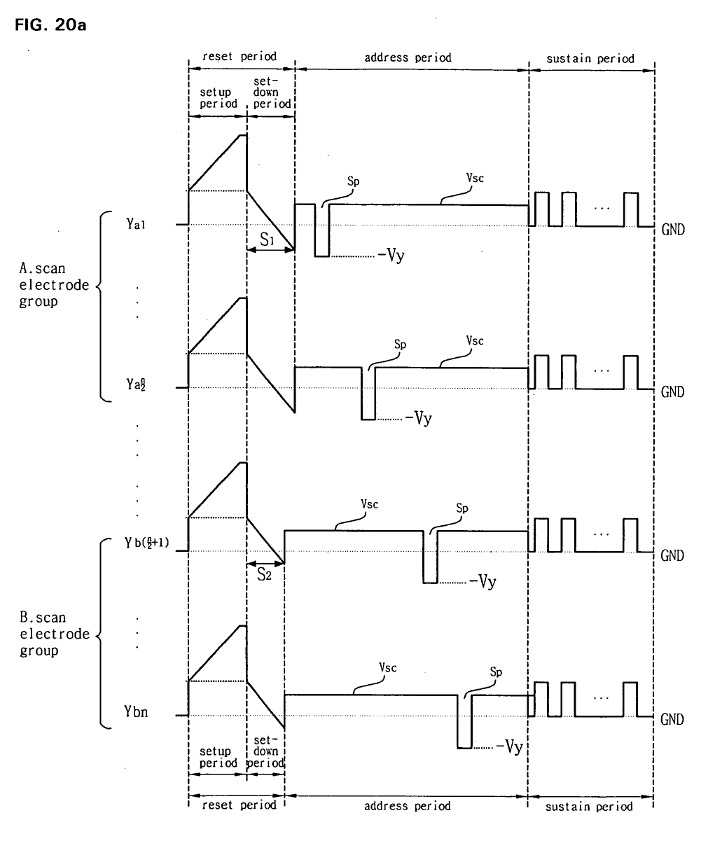

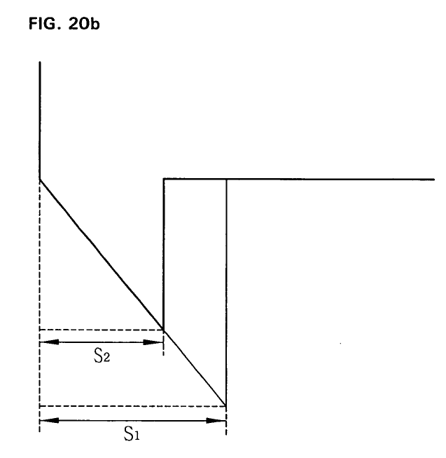

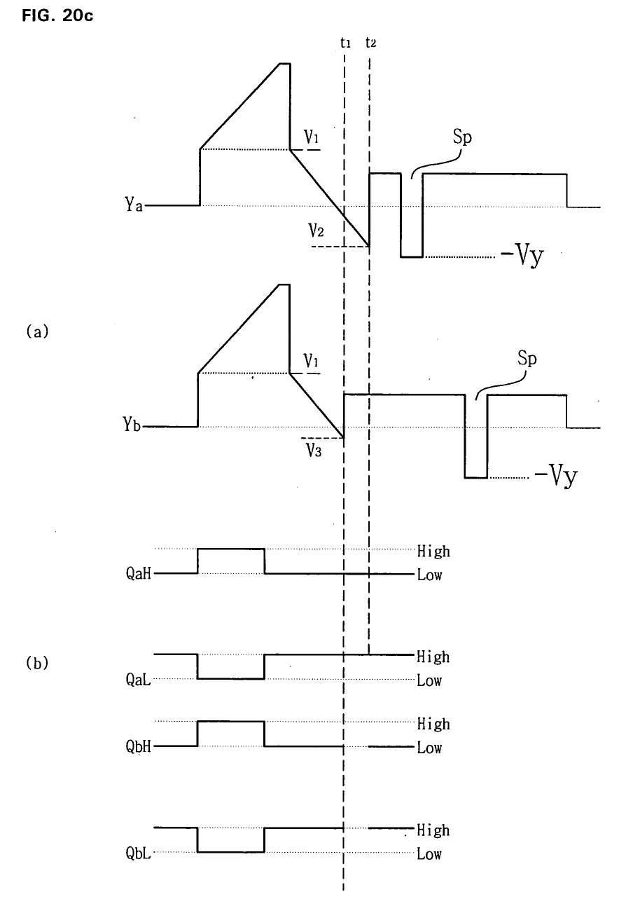

FIGS. 20a and 20b illustrate further still another driving signal of the plasma display apparatus according to the second embodiment of the present invention.

As shown in FIG. 20a, a scan driver of a plasma display apparatus according to the second embodiment of the present invention may make the lowest voltage of a set-down pulse high by the difference between periods S1, S2 when the set-down pulse is supplied, as the scanning order becomes late. For example, as shown in FIGS. 20a and 20b, the scan driver supplies set-down pulses having the same slope to A scan electrode group and B scan electrode group, and makes the supply period S1 of the set-down pulse to be supplied to the A scan electrode group longer than the supply period S2 of the set-down pulse to be supplied to the B scan electrode group.

FIG. 20c is a timing diagram for an operation of the scan driver according to the second embodiment of the present invention. The timing diagram of FIG. 20c is described with reference to the scan driver of FIG. 12c.

The fifth switch Q5 of the set-down supplying unit 150 is turned on at the set-down period of the reset period. In addition, scan bottom switches QaL, QbL of the scan drive integrated circuits 140-1, 140-2 are turned on, and their scan top switches QaH, QbH are turned off. Accordingly, the voltage of the A scan electrode group Ya and B scan electrode group Yb falls gradually from the first voltage V1.

The scan bottom switch QbL of the scan drive integrated circuit 140-2 is turned off at point of time t1, and the scan top switch QbH is turned on at point of time t1. In addition, the scan top switch QaH and scan bottom switch QaL of the scan drive integrated circuit 140-1 maintain the switching state at point of time t1. Accordingly, the voltage of the A scan electrode group Ya falls up to the second voltage V2, and the voltage of the B scan electrode group Yb falls up to the third voltage V3.

### <Third Embodiment>

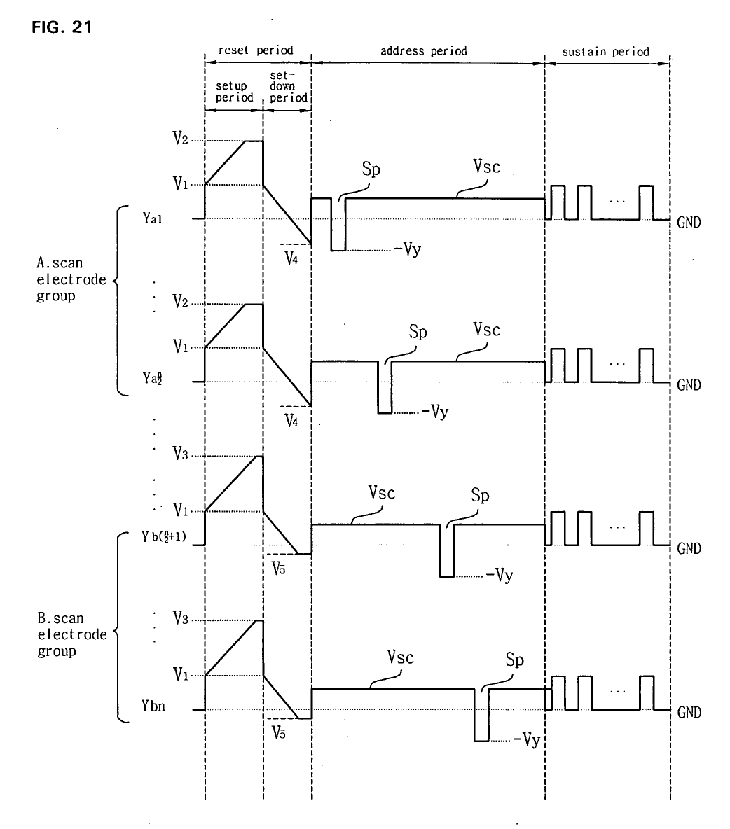

FIG. 21 illustrates a driving signal of a plasma display apparatus according to a third embodiment of the present invention. As shown in FIG. 21, a scan driver of a plasma display apparatus according to the third embodiment of the present invention makes the highest voltage of the setup pulse and the lowest voltage of the set-down pulse high as the scanning order becomes late. For example, the scan driver supplies the A scan electrode group having faster scanning order with a first setup pulse rising gradually from a first voltage V1 to a second voltage V2, and supplies the B scan electrode group having slower scanning order with a second setup pulse rising gradually from the first voltage VI to a third voltage V3. The third voltage V3 is higher than the second voltage V2.

In addition, the scan driver supplies the A scan electrode group having faster scanning order with a first set-down pulse falling gradually from a first voltage VI to a fourth voltage V4, and supplies the B scan electrode group having slower scanning order with a second set-down pulse rising gradually from the first voltage V1 to a fifth voltage V5. The fifth voltage V5 is higher than the third voltage V3.

The embodiment of the invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A method of driving a plasma display apparatus comprising an m-th scan electrode group and an n-th scan electrode group scanned later than the m-th scan electrode group, the method comprising:
supplying a first setup pulse rising from a first voltage to a second voltage to the m-th scan electrode group during a setup period of a reset period; and
supplying a second setup pulse rising from the first voltage to a third voltage that is higher than the second voltage to the n-th scan electrode group during the setup period of the reset period.

2. The method of claim 1, wherein a duration of time when the first setup pulse is maintained at the second voltage is higher than a duration of time when the second setup pulse is maintained at the third voltage.

3. The method of claim 1, wherein a slope of the first setup pulse is substantially equal to a slope of the second setup pulse.

4. The method of claim 1, wherein the number of scan electrodes comprised in the m-th scan electrode group is equal to the number of scan electrodes comprised in the n-th scan electrode group.

5. The method of claim 1, wherein as the number of scan electrodes comprised in the m-th scan electrode group increases, a magnitude of the second voltage increases.

6. The method of claim 1, wherein a duration of a supply period of the first setup pulse is less than a duration of a supply period of the second setup pulse.

7. The method of claim 1, wherein a duration of a supply period of a set-down pulse supplied to the m-th scan electrode group is substantially equal to a duration of a supply period of a set-down pulse supplied to the n-th scan electrode group.

8. A method of driving a plasma display apparatus comprising a p-th scan electrode and a q-th scan electrode scanned later than the p-th scan electrode, the method comprising:
supplying a first setup pulse rising from a first voltage to a second voltage to the p-th scan electrode during a setup period of a reset period; and
supplying a second setup pulse rising from the first voltage to a third voltage that is higher than the second voltage to the q-th scan electrode during the setup period of the reset period.

9. The method of claim 8, wherein the p-th scan electrode and the q-th scan electrode are adjacent to each other, and
after completing the supplying of a scan pulse to the p-th scan electrode, a scan pulse is supplied to the q-th scan electrode subsequent to a pause period.

10. The method of claim 9, wherein a duration of the pause period ranges from 50 ns to 100 μs.

11. A method of driving a plasma display apparatus comprising an m-th scan electrode group and an n-th scan electrode group scanned later than the m-th scan electrode group, the method comprising:
supplying a first set-down pulse falling from a first voltage to a second voltage to the m-th scan electrode group during a set-down period of a reset period; and
supplying a second set-down pulse falling from the first voltage to a third voltage that is higher than the second voltage to the n-th scan electrode group during the set-down period of the reset period.

12. The method of claim 11, wherein a duration of time when the first set-down pulse is maintained at the second voltage is less than a duration of time when the second set-down is maintained at the third voltage.

13. The method of claim 11, wherein a slope of the first set-down pulse is substantially equal to a slope of the second set-down pulse.

14. The method of claim 11, wherein the number of scan electrodes comprised in the m-th scan electrode group is equal to the number of scan electrodes comprised in the n-th scan electrode group.

15. The method of claim 11, wherein as the number of scan electrodes comprised in the n-th scan electrode group decreases, a magnitude of the third voltage increases.

16. The method of claim 11, wherein a duration of a supply period of the first set-down pulse is more than a duration of a supply period of the second set-down pulse.

17. The method of claim 11, wherein a duration of a supply period of a set-up pulse supplied to the m-th scan electrode group is substantially equal to a duration of a supply period of a set-down up supplied to the n-th scan electrode group.

18. A method of driving a plasma display apparatus comprising a p-th scan electrode and a q-th scan electrode scanned later than the p-th scan electrode, the method comprising:
supplying a first set-down pulse falling from a first voltage to a second voltage to the p-th scan electrode during a set-down period of a reset period; and
supplying a second set-down pulse falling from the first voltage to a third voltage that is higher than the second voltage to the q-th scan electrode during the set-down period of the reset period.

19. The method of claim 18, wherein the p-th scan electrode and the q-th scan electrode are adjacent to each other, and
after completing the supplying of a scan pulse to the p-th scan electrode, a scan pulse is supplied to the q-th scan electrode subsequent to a pause period.

20. The method of claim 19, wherein a duration of the pause period ranges from 50 ns to 100 μs.
